(19) United States
(12) Patent Application Publication
(10) Pub. No.: US 2014/0172862 A1
(43) Pub. Date: Jun. 19, 2014

(54) ELECTRONIC DEVICE AND METHOD FOR SORTING APPLICATIONS

(71) Applicant: FIH (Hong Kong) Limited, Kowloon (HK)

(72) Inventor: PO-SHANE WU, New Taipei (TW)

(73) Assignee: FIH (HONG KONG) LIMITED, Kowloon (HK)

(21) Appl. No.: 14/038,804

(22) Filed: Sep. 27, 2013

(30) Foreign Application Priority Data
Dec. 14, 2012 (TW) 101147696

(51) Int. Cl. G06F 17/30

(52) U.S. Cl. CPC G06F 17/30598
USPC 707/740

(57) ABSTRACT

In a method for sorting applications of an electronic device, different application categories, time types, and area types are defined. A first association between the application categories and the time types and a second association between the application categories and the area types are defined. If the applications are sorted by time, a current date, a time type of the current date, and an application category corresponding to the determined time type are determined. Applications classified into the determined application category are displayed on a display screen ahead of the other applications. If the applications are sorted by area, a current location of the electronic device, an area type of the current location, and an application category corresponding to the determined area type are determined. Applications classified into the determined application category are displayed on the display screen ahead of the other applications.

### BACKGROUND

1. Technical Field

The embodiments of the present disclosure relate to application management, and particularly to an electronic device and a method for sorting applications of the electronic device.

21. Description of Related Art

Electronic devices, such as mobile phones, are increasingly equipped with more functions. As a result, more applications are provided in the electronic devices. Display sequences of the applications may be fixed. Sometimes it is inconvenient for users to locate a required application in different circumstances.

### BRIEF DESCRIPTION OF THE DRAWINGS

FIG. 1 is one embodiment of an electronic device including a sorting system.

FIG. 2 is a block diagram of one embodiment of function modules of the sorting system of the electronic device in FIG. 1.

FIG. 3 is a flowchart of one embodiment of a method for sorting applications of the electronic device in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, JAVA, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

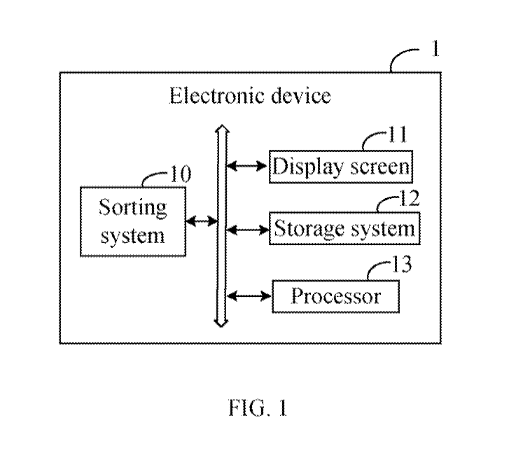

FIG. 1 is one embodiment of an electronic device 1 including a sorting system 10. The electronic device 1 further includes a display screen 11, a storage system 12, and at least one processor 13. The sorting system 10 displays applications, which are installed in the electronic device 1, on the display screen 11 in an ordered sequence based on time or location, to facilitate users to locate a required application. Each application may be represented by an icon displayed on the display screen 11.

The storage system 12 may be a dedicated memory, such as an EPROM, a hard disk drive (HDD), or flash memory. In some embodiments, the storage system 12 may also be an external storage device, such as an external hard disk, a storage card, or other data storage medium.

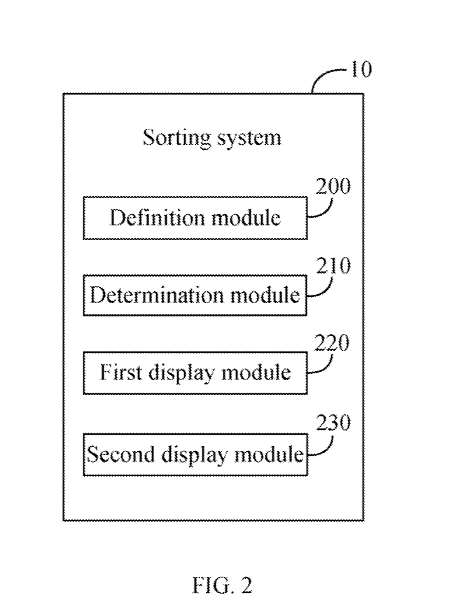

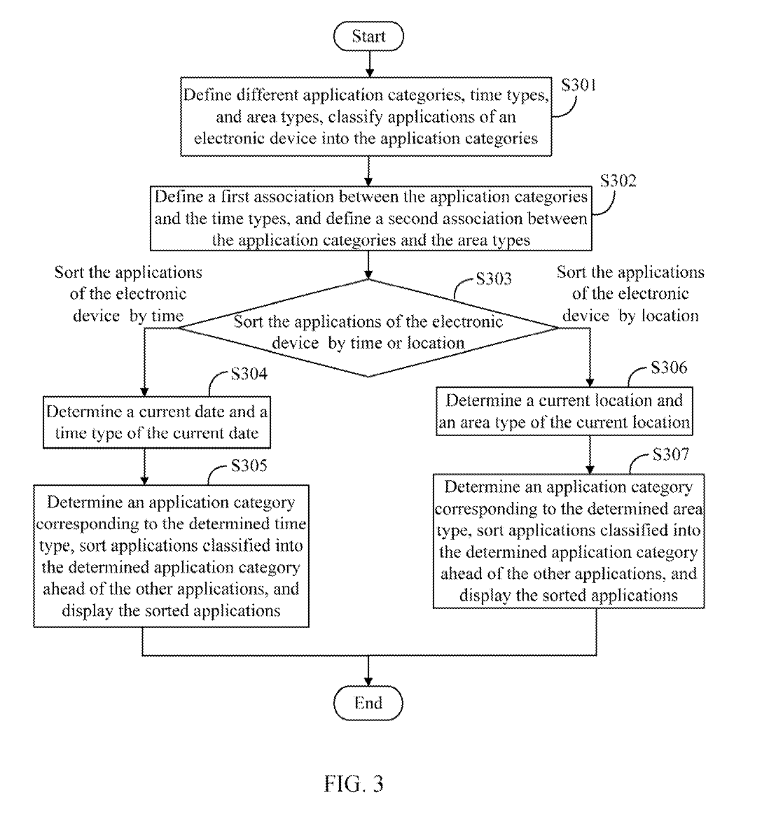

FIG. 2 is a block diagram of one embodiment of function modules of the sorting system 10 in FIG. 1. The sorting system 10 includes a definition module 200, a determination module 210, a first display module 220, and a second display module 230. The modules 200-230 may comprise computerized code in the form of one or more programs that are stored in the storage system 12. The computerized code includes instructions that are executed by the at least one processor 13, to provide the aforementioned functions of the sorting system 10. A detailed description of the functions of the modules 200-230 is given below in reference to FIG. 3.

FIG. 3 is a flowchart of one embodiment of a method for sorting applications of the electronic device 1 in FIG. 1. Depending on the embodiment, additional steps may be added, others removed, and the ordering of the steps may be changed.

In step S301, the definition module 200 defines different application categories, and classifies the applications installed in the electronic device 1 into the application categories. Each of the applications is classified into one application category. For example, the applications of the electronic devices 10 include notebook, calendar, email, calculator, diary, memo, music player, game, and video player. The application categories include a first application category of work applications and a second application category of leisure applications. Notebook, calendar, email, calculator, diary, memo are classified into the first application category. Music player, game, and video player are classified into the second application category. The definition module 200 defines different time types based on days of a year. For example, the time types include a first time type of working days and a second time type of rest days. The first time type of dates includes holidays and weekends. The second time type of dates includes the other dates. The definition module 200 further defines different area types based on locations into the area types. In one example, the area types include a first area type of working areas and a second area type of private areas.

In step S302, the definition module 200 defines a first association between the application categories and the time types, and defines a second association between the application categories and the area types. According to the first association, if a time type is determined, an application category corresponding to the time type is determined. For example, if the first time type is determined, a corresponding application category is the first application category. According to the second association, if an area type is determined, an application category corresponding to the area type is determined. For example, if the first area type is determined, a corresponding application category is the first application category.

In step S303, the determination module 210 determines whether the applications of the electronic device 1 are sorted by time or by location. If the applications are sorted by time, steps S304-S305 are executed. If the applications are sorted by location, steps S306-S307 are executed. The determination module 210 may determine whether the applications of the electronic device 1 are sorted by time or by location according to a user's selection.

When the applications are sorted by time, in step S304, the first display module 220 determines a current date, and determines a time type of the current date. For example, the first display module 220 determines that the current date is November 27, 2012, and determines that the time type of the current date is the first time type. In the illustrated embodiment, the first display module 220 may determine the current date according to a system time of the electronic device 1. Depending on the embodiment, the electronic device 1 may be connected to a time server. The first display module 220 may obtain the current date from the time server.

In step S305, the first display module 220 determines an application category corresponding to the determined time type according to the first association, sorts applications classified into the determined application category ahead of the other applications, and displays the sorted applications on the display screen 11. For example, the current date is a working day and the time type of the current date is the first time type. The application category corresponding to the time type of the current date is the first application category. Therefore, the first display module 220 sorts notebook, calendar, email, calculator, diary, and memo ahead of music player, game, and video player, and displays notebook, calendar, email, calculator, diary, and memo on the display screen 11 ahead of music player, game, and video player. In the illustrated embodiment, the first display module 220 arranges applications classified into the same application category alphabetically. Depending on the embodiment, the first display module 220 may not display applications that are not classified into the determined application category on the display screen 11.

When the applications are sorted by area, in step S306, the second display module 230 determines a current location of the electronic device 1, and determines an area type of the current location. For example, the second display module 230 determines that the current location of the electronic device 1 is an office, and determines that the area type of the current location is the first area type. In this embodiment, the second display module 230 may determine the current location of the electronic device 1 according to a network connection of the electronic device 1. For example, if the electronic device 1 is connected to a local area network of a company, the current location of the electronic device 1 is determined to be an office. Depending on the embodiment, the second display module 230 may determine the current location of the electronic device 1 using a positioning device embedded in the electronic device 1.

In step S307, the second display module 230 determines an application category corresponding to the determined area type according to the second association, sorts applications classified into the determined application category ahead of the other applications, and displays the sorted applications on the display screen 11. For example, the current location of the electronic device 1 is an office and the area type of the current location of the electronic device is the first time type. The application category corresponding to the area type of the current location is the first application category. Therefore, the second display module 230 sorts notebook, calendar, email, calculator, diary, and memo ahead of music player, game, and video player, and displays notebook, calendar, email, calculator, diary, and memo on the display screen 11 ahead of music player, game, and video player. In this embodiment, the second display module 230 arranges applications classified into the same application category alphabetically. Depending on the embodiment, the second display module 230 may not display applications that are not classified into the determined application category on the display screen 11.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for sorting applications of an electronic device being executed by a processor of the electronic device, the method comprising:
defining different application categories, and classifying the applications of the electronic device into the application categories;
defining different time types based on days of a year;
defining different area types based on locations of the electronic device;
defining a first association between the application categories and the time types, and defining a second association between the application categories and the area types;
determining whether the applications of the electronic device are sorted by time or by location;
in response to determining that the applications are sorted by time, determining a current date and a time type of the current date, determining an application category corresponding to the determined time type according to the first association, sorting applications classified into the determined application category ahead of the other applications, and displaying the sorted applications on a display screen of the electronic device; and
in response to determining that the applications are sorted by area, determining a current location of the electronic device and an area type of the current location, determining an application category corresponding to the determined area type according to the second association, sorting applications classified into the determined application category ahead of the other applications, and displaying the sorted applications on the display screen.

2. The method of claim 1, wherein the application categories comprise a first application category of work applications and a second application category of leisure applications.

3. The method of claim 1, wherein the time types comprise a first time type of working days and a second time type of rest days.

4. The method of claim 1, wherein the area types comprise a first area type of working areas and a second area type of private areas.

5. The method of claim 1, wherein the current location of the electronic device is determined according to a network connection of the electronic device.

6. An electronic device, comprising:
a display screen;
at least one processor; and
a storage system storing a plurality of instructions, when executed by the at least one processor, causing the at least one processor to perform operations comprising:
defining different application categories, and classifying the applications of the electronic device into the application categories;
defining different time types based on days of a year;
defining different area types based on locations of the electronic device;
defining a first association between the application categories and the time types, and defining a second association between the application categories and the area types;
determining whether the applications of the electronic device are sorted by time or by location;
in response to determining that the applications are sorted by time, determining a current date and a time type of the current date, determining an application category corresponding to the determined time type according to the first association, sorting applications classified into the determined application category ahead of the other applications, and displaying the sorted applications on the display screen; and
in response to determining that the applications are sorted by area, determining a current location of the electronic device and an area type of the current location, determining an application category corresponding to the determined area type according to the second association, sorting applications classified into the determined application category ahead of the other applications, and displaying the sorted applications on the display screen.

7. The electronic device of claim 6, wherein the application categories comprise a first application category of work applications and a second application category of leisure applications.

8. The electronic device of claim 6, wherein the time types comprise a first time type of working days and a second time type of rest days.

9. The electronic device of claim 6, wherein the area types comprise a first area type of working areas and a second area type of private areas.

10. The electronic device of claim 6, wherein the current location of the electronic device is determined according to a network connection of the electronic device.

11. A non-transitory computer-readable storage medium storing a set of instructions, the set of instructions capable of being executed by a processor of an electronic device to implement a method for sorting applications of the electronic device, the method comprising:
defining different application categories, and classifying the applications of the electronic device into the application categories;
defining different time types based on days of a year;
defining different area types based on locations of the electronic device;
defining a first association between the application categories and the time types, and defining a second association between the application categories and the area types;
determining whether the applications of the electronic device are sorted by time or by location;
in response to determining that the applications are sorted by time, determining a current date and a time type of the current date, determining an application category corresponding to the determined time type according to the first association, sorting applications classified into the determined application category ahead of the other applications, and displaying the sorted applications on a display screen of the electronic device; and
in response to determining that the applications are sorted by area, determining a current location of the electronic device and an area type of the current location, determining an application category corresponding to the determined area type according to the second association, sorting applications classified into the determined application category ahead of the other applications, and displaying the sorted applications on the display screen.

12. The storage medium of claim 11, wherein the application categories comprise a first application category of work applications and a second application category of leisure applications.

13. The storage medium of claim 11, wherein the time types comprise a first time type of working days and a second time type of rest days.

14. The storage medium of claim 11, wherein the area types comprise a first area type of working areas and a second area type of private areas.

15. The storage medium of claim 11, wherein the current location of the electronic device is determined according to a network connection of the electronic device.
